(19) United States
(12) Patent Application Publication
(10) Pub. No.: US 2010/0183156 A1
(43) Pub. Date: Jul. 22, 2010

(54) AUDIO SYSTEM AND METHOD TO CONTROL OUTPUT OF THE AUDIO SYSTEM

(75) Inventors: Chan Ho PARK, Seoul (KR); Yong Gone Kim, Yongin-si (KR); Hye Young Cha, Yongin-si (KR); Mi Kyoung Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/573,207

(22) Filed: Oct. 5, 2009

(30) Foreign Application Priority Data
Jan. 16, 2009 (KR) 2009-3839

(51) Int. Cl. H04R 5/00; G10K 11/16

(52) U.S. Cl. 381/17; 381/71.1; 381/71.8

(57) ABSTRACT

An audio system and a method to control the output of the audio system are provided. The audio system includes a source unit having an audio signal, a receiver to receive the audio signal and generate a cancellation signal to cancel the audio signal, a first speaker to output the audio signal, and a second speaker to output the cancellation signal.

### CROSS-REFERENCE TO RELATED APPLICATIONS

This application claims priority from Korean Patent Application No. 10-2009-003839, filed on Jan. 16, 2009 in the Korean Intellectual Property Office, the disclosure of which is incorporated herein by reference.

### BACKGROUND

1. Field of the Invention

Exemplary embodiments of the present invention relate to an audio system to control the output of an audio signal and a method to control the output of the audio system.

2. Description of the Related Art

Generally, an audio system deals with sound waves in a sound range audible to the human ear and electrical signals converted from the sound waves. The audio system includes an Audio/Video (AV) receiver and multi-channel speakers. The AV receiver may be, for example, an FM/AM radio, a CD player with an amplifier to amplify sound integrated therein, a DVD player, a cassette deck, or the like.

The audio system is connected to a video device, thus forming an AV system. The AV system decodes and amplifies a sound signal from an AV source and outputs the amplified audio signal and a video signal simultaneously. One of AV systems is a home theater system.

The home theater includes an AV source device, a video device such as a TV, an AV receiver, and six 5.1-channel speakers. The AV source device may be a VCR, a set-top box, a DVD player, or the like. The AV source device outputs an audio signal to the AV receiver and a video signal to the video device. The AV receiver digitally processes the audio signal, amplifies the processed audio signal, and outputs the amplified audio signal to the respective multi-channel speakers. The 5.1-channel speakers to output audio signals are a center speaker, left and right front speakers, left and right rear speakers, and a woofer speaker. The home theater system may use speakers that deliver sound on more channels, instead of the 5.1-channel speakers.

When the user views a film from a home theater system with speakers of 5.1 channels, or speakers of less or more than 5.1 channels at night, it may bother others' sleep and, if the user lives in an officetel (i.e., a mixed-use building) or an apartment, it may make too much noise and disturb other households. However, turning down of the volume of each channel speaker nullifies the sound effect of the 5.1-channel speakers or the speakers of less or more than 5.1 channels. If the speakers are adjusted to too low of a volume, the speaker of the video device will not be viable.

### SUMMARY

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention provides an audio system including a source unit having an audio signal, a receiver to receive the audio signal and generate a cancellation signal to cancel the audio signal, a first speaker to output the audio signal, and a second speaker to output the cancellation signal.

The second speaker may include a plurality of speakers.

The audio signal may be a multi-channel audio signal and the receiver may downmix the multi-channel audio signal and transmit the downmixed signal to the first speaker.

The cancellation signal may be a phase-inverted signal of the downmixed signal.

The audio system may further include a mode setter to set noise canceling mode and the receiver may control the generating and output of the cancellation signal if the noise canceling mode is set.

The receiver may count a current time, compare the count with a predetermined time, and set the noise canceling mode, in which the cancellation signal is generated and output, according to the comparing of the count with the predetermined time.

Another aspect of the present invention provides an audio system including a receiver having an audio signal, a first speaker to output the audio signal, and a second speaker, which has an inverting filter to invert a phase of the audio signal, to output the phase-inverted signal as a cancellation signal.

Another aspect of the present invention provides an audio system including a receiver having an audio signal, a first speaker to output the audio signal, and a second speaker having a sound sensor to sense sound output from the first speaker and a signal processor to generate a cancellation signal to cancel the audio signal, to output the cancellation signal.

Another aspect of the present invention provides an audio system including a speaker unit to output an audio signal, a sound sensor to sense the audio signal output from the speaker unit, and a receiver to generate a cancellation signal to cancel the audio signal, and to output the cancellation signal to the speaker unit.

The speaker unit may include a plurality of speakers, at least one of the plurality of speakers may output the audio signal, and the other speakers of the plurality of speakers may output the cancellation signal.

The audio signal may be a multi-channel audio signal and the speaker unit may include a main part to output a downmixed signal of the multi-channel audio signal and a sub-part to output the cancellation signal.

The cancellation signal may be a phase-inverted signal of the sensed audio signal sensed by the sound sensor.

The audio system may further include a mode setter to set noise canceling mode, wherein the receiver may control the generating and output of the cancellation signal, if the noise canceling mode is set.

The receiver may count a current time, compare the count with a predetermined time, and set the noise canceling mode in which the cancellation signal is generated and output, according to the comparing of the count with the predetermined time.

Another aspect of the present invention provides a method to control output of an audio system including determining whether a current mode is noise canceling mode, generating a cancellation signal to cancel an audio signal, wherein the generating of the cancellation signal is performed upon receipt of the audio signal from a source unit, if the current mode is the canceling mode, and outputting the audio signal and the cancellation signal simultaneously through different speakers.

The outputting of the audio signal may include downmixing the audio signal and outputting the downmixed signal to a speaker of the different speakers.

The determining whether the current mode is the noise canceling mode may include determining whether the noise canceling mode has been set through a mode setter.

The determination as to whether the current mode is the noise canceling mode may include determining whether a current time is a predetermined time.

A further aspect of the present invention provides a method to control output of an audio system including determining whether a current mode is a noise canceling mode, outputting an audio signal through a first speaker, if the current mode is the canceling mode, sensing the audio signal output from the first speaker, generating a cancellation signal to cancel a signal of the sensed audio signal, and outputting the cancellation signal to a second speaker.

The first speaker and the second speaker may be a main part and a sub-part, respectively, of a single speaker.

### BRIEF DESCRIPTION OF THE DRAWINGS

These and/or other aspects of the invention will become apparent and more readily appreciated from the following description of the exemplary embodiments, taken in conjunction with the accompanying drawings of which:

FIG. 1 is a schematic diagram illustrating the configuration of a home theater having an audio system according to an exemplary embodiment of the present invention;

FIG. 2 is a control block diagram of the home theater having an audio system (an example of which is shown in FIG. 1);

FIG. 3 is a flowchart illustrating a method to control the output of an audio system (an example of which is shown in FIG. 1) according to an exemplary embodiment of the present invention;

FIG. 4 is a schematic diagram illustrating the configuration of a home theater having an audio system according to another exemplary embodiment of the present invention;

FIG. 5 is a control block diagram of the home theater having an audio system (an example of which is shown in FIG. 4);

FIG. 6 is a schematic perspective view of a center speaker in an audio system (an example of which is shown in FIG. 4) according to another exemplary embodiment of the present invention; and

FIG. 7 is a flowchart illustrating a method to control the output of an audio system (an example of which is shown in FIG. 4) according to another exemplary embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout.

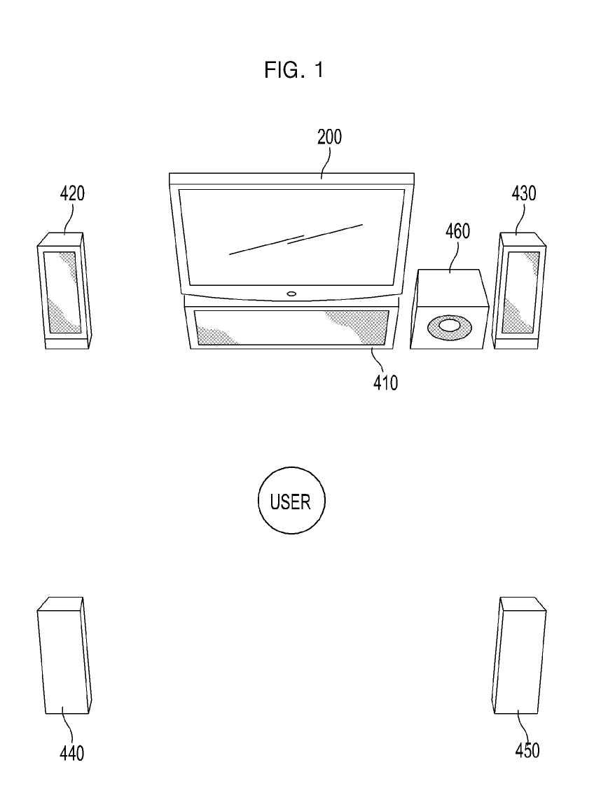

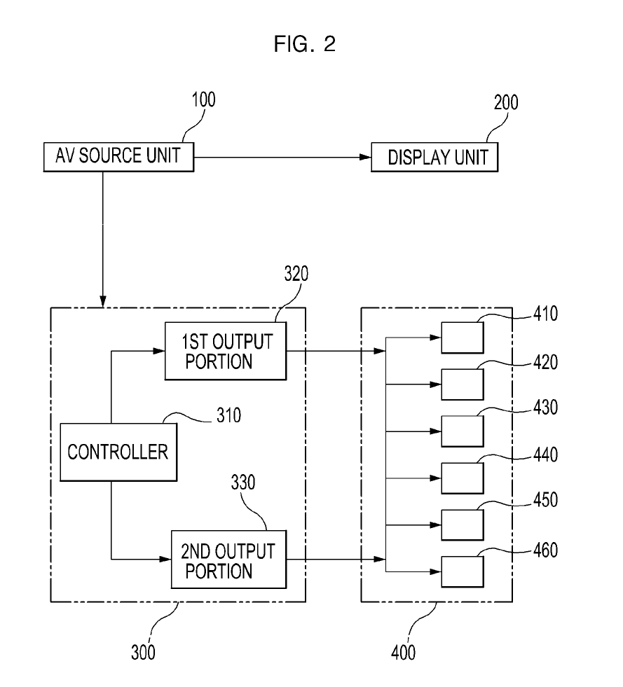

FIG. 1 is a schematic diagram illustrating the configuration of a home theater having an audio system according to an exemplary embodiment of the present invention. FIG. 2 is a control block diagram of the home theater having an audio system, such as the audio system shown in FIG. 1. The following description is made in the context of an audio system having 5.1-channel speakers, by way of example.

Referring to FIGS. 1 and 2, the home theater system having the audio system includes an AV source unit 100, a display unit 200, an AV receiver 300, and a speaker unit 400.

The AV source unit 100 may be a Personal Video Recorder (PVR), a DVD, or a Set-Top Box (STB), for example. The AV source unit 100 reads a medium that stores digital audio or video streams and transmits a video signal to the display unit 200 and an audio signal to the AV receiver 300.

The display unit 200 decompresses the compressed video signal received from the AV source unit 100 and displays the decompressed video signal on a screen.

The AV receiver 300 decompresses the compressed audio signal received from the AV source unit 100 and transmits the decompressed audio signal to a plurality of speakers. The AV receiver 300 includes a controller 310 to control the output of an audio signal, a first output portion 320 to output the audio signal, and a second output portion 330 to output a phase-inverted signal of the audio signal.

More specifically, the controller 310 determines whether a current mode is normal mode or Night Noise Canceling (NNC) mode. While the current exemplary embodiment describes a “Night” Noise Canceling mode, it should be noted that the present invention is not limited to a strict or literal interpretation of the word “night.” That is, the present invention is not limited to the implementing of such a noise canceling mode, as described herein, only at nighttime. If the current mode is the normal mode, the controller 310 transmits audio signals of a plurality of channels (i.e. 5.1-channel audio signals) received from the AV source unit 100 to the first output portion 320. The first output portion 320 outputs an audio signal corresponding to human voice such as a dialogue to a center speaker 410, an audio signal corresponding to sound effects such as music and effect sound to left and right front speakers 420 and 430, an audio signal corresponding to effect sound, surrounding sound, and background sound to left and right rear speakers 440 and 450, and an audio signal corresponding to mid-base sound to a woofer speaker 460.

If the current mode is the NNC mode, the controller 310 downmixes audio signals of a plurality of channels (i.e. 5.1-channel audio signals) received from the AV source unit 100 and outputs the downmixed signal to the first output portion 320. The first output portion 320 transmits the downmixed signal to the center speaker 410 being a first speaker. The controller 310 generates a cancellation signal by inverting the phase of the downmixed signal and outputs the cancellation signal to the second output portion 330. The second output portion 330 outputs the cancellation signal to the left and right front speakers 420 and 430 and the left and right rear speakers 440 and 450. Herein the left and right front speakers 420 and 430 and the left and right rear speakers 440 and 450 are second speakers. The woofer speaker 460 is kept in a mute state. In this way, the NNC mode may maintain a quiet and comfortable atmosphere.

A speaker unit 400 includes the multi-channel speakers that output 5.1-channel audio signals. The multi-channel speakers are the center speaker 410 at the front center of the display unit 200, the front speakers 420 and 430 at the left and right sides of the display unit 200, the left and right rear speakers 440 and 450 behind a user, and the woofer speaker 460.

In the normal mode, the first speaker, namely the center speaker 410 outputs clean dialogues from a film and the left and right front speakers 420 and 430 being second speakers output musical scores or some dialogues, and a variety of sound effects, thus creating the feeling of a natural and expansive stage set. The other second speakers, the left and right rear speakers 440 and 450 give a touching feeling by outputting additional effect sound, surrounding sound, and background sound, besides the sounds of the front speakers 420 and 430. The woofer speaker 460 outputs mid-bass sound, thereby giving reality and liveliness in conjunction with the front speakers 420 and 430.

In the NNC mode, the first speaker, namely the center speaker 410 outputs a downmix of 5.1-channel audio signals and the second speakers, namely the left and right front speakers 420 and 430 and the left and light rear speakers 440 and 450, output a phase-inverted signal of the downmixed signal (i.e., a cancellation signal).

The center speaker 410 includes a main part and a sub-part. The main part outputs a downmix of 4.1 channels (e.g., audio signals output from the left and right rear speakers 440 and 450 and the left and right front speakers 420 and 430 in the normal mode) except human voice such as dialogues, etc. and the sub-part outputs a signal corresponding to human voice like dialogues, etc. (e.g., an audio signal output from the center speaker 410 in the normal mode).

The audio system may further include a mode setter (not shown) to set the current mode to the NNC mode according to user selection. Or it may be further contemplated that a current time is counted, the count is compared with a predetermined time, and the current mode is set to the NNC mode if the current time is the predetermined time, through the AV receiver 300.

In an audio system according to another exemplary embodiment of the present invention, the AV receiver 300 includes the controller 310 to control the output of an audio signal, the first and second output portions 320 and 330 to output audio signals, and an inverting filter (not shown) to invert the phase of an audio signal.

To be more specific, the controller 310 downmixes multi-channel audio signals. The second output portion 330 transmits the downmixed signal received from the controller 310 to the inverting filter. The inverting filter inverts the phase of the downmixed signal, thus producing a cancellation signal and outputs the cancellation signal to the second speakers, namely the left and right front speakers 420 and 430 and the left and right rear speakers 440 and 450. An inverting filter (not shown) is provided at each of the left and right front speakers 420 and 430 and the left and right rear speakers 440 and 450, or at the AV receiver 300. In this case, the phase-inverted signal is directly output without a phase inverting process. Therefore, the time required for outputting the phase-inverted signal is minimized.

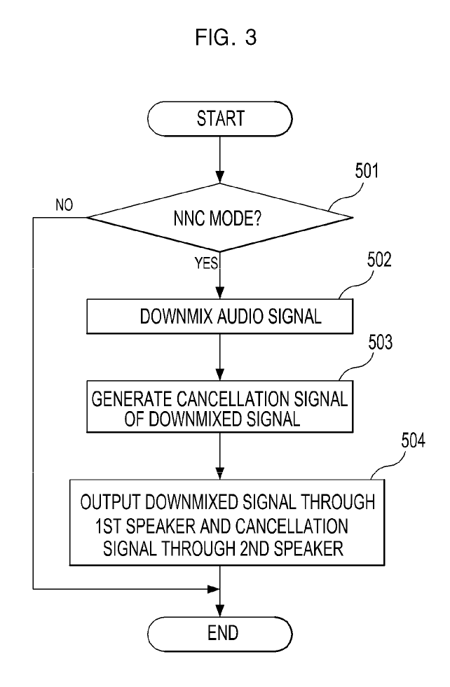

FIG. 3 is a flowchart illustrating a method to control the output of the audio system of FIG. 1 according to an exemplary embodiment of the present invention. The output control method will be described with reference to FIGS. 1 and 2.

Upon receipt of an audio signal from the AV source unit 100 such as a PVR, a DVD player or an STB, the controller 310 determines whether a current mode is the normal mode or the NNC mode and transmits signals to the first and second output portions 320 and 330 according to the result of the determination. Meanwhile, the display unit 200 decompresses a compressed video signal received from the AV source unit 100 and displays the decompressed video signal on the screen.

To be more specific, if the current mode is the normal mode, the AV receiver 300 decompresses a compressed audio signal received from the AV source unit 300 and outputs the decompressed audio signal to the first output portion 320. The first output portion 320 outputs the audio signal through each speaker. The center speaker 410 as the first speaker outputs clean dialogues, the woofer speaker 460 outputs mid-bass sound, the left and right front speakers 420 and 430 output a variety of sound effects, and the left and right rear speakers 440 and 450 output additional effect sounds, surrounding sound, and background sound with respect to the sounds output from the front speakers 420 and 430.

On the other hand, if the current mode is the NNC mode in operation 501, the AV receiver 300 decompresses the compressed audio signal received from the AV source unit 300 and downmixes the decompressed signal and outputs the downmixed signal to the first output portion 320 in operation 502. The AV receiver 300 generates a cancellation signal by inverting the phase of the downmixed signal and outputs the cancellation signal to the second output portion 330 in operation 503.

Thus the downmixed signal is output to the center speaker 410 being the first speaker and the cancellation signal is output to the second speakers, that is, the left and right front speakers 420 and 430 and the left and right rear speakers 440 and 450 in operation 504.

The center speaker 410 has the main part and the sub-part. The main part outputs a downmix of 4.1 channels (audio signals output from the left and right rear speakers and the left and right front speakers in the normal mode) except human voice such as dialogues, etc. and the sub-part outputs a signal corresponding to human voice like dialogues, etc. (an audio signal output from the center speaker in the normal mode).

In this manner, during playing a TV or any other medium, a phase-inverted signal (i.e., a cancellation signal) with the same frequency as and an opposite phase to an audio signal is generated and output together with the audio signal, thereby canceling the audio signal. As a result, prevention of sound propagation outside an area in which the home theater is installed may be achieved, and further, an increased linearity of the audio signal may increase reproduction satisfaction and improve product performance. That is, if noise made during playing a medium does not go out and external noise is not introduced inside, the installation area of the home theater may be turned into a user's private space.

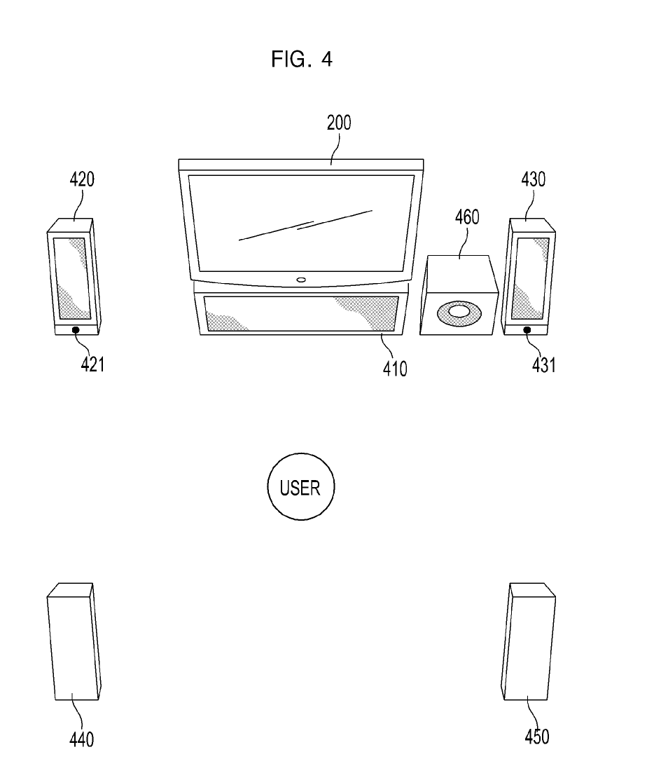

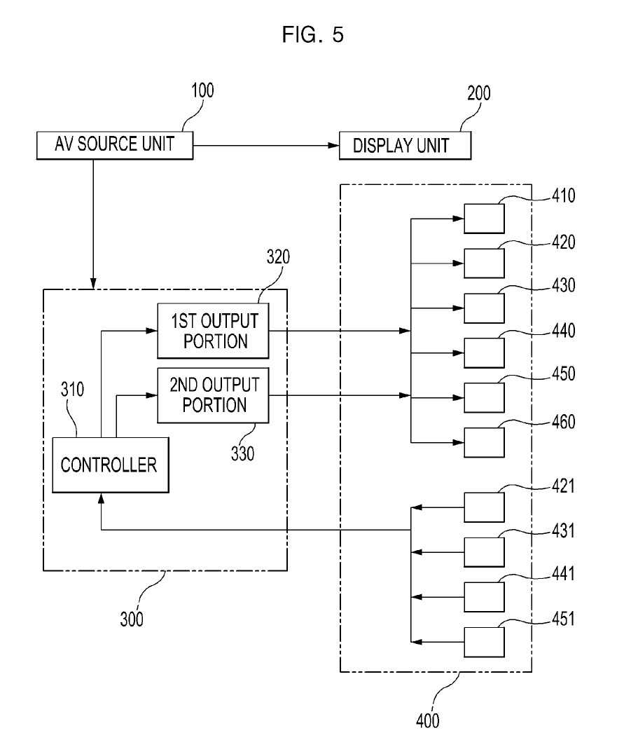

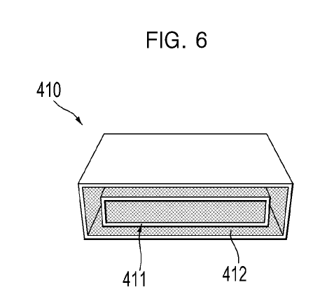

FIG. 4 is a schematic diagram illustrating the configuration of a home theater having an audio system according to another exemplary embodiment of the present invention and FIG. 5 is a control block diagram of the home theater having the audio system of FIG. 4. And FIG. 6 is a schematic perspective view of a center speaker in the audio system of FIG. 4. The audio system has 5.1-channel speakers, by way of example.

The AV source unit 100 is a PVR, a DVD, or an STB. The AV source unit 100 reads a medium that stores digital audio or video streams and transmits a video signal to the display unit 200 and an audio signal to the AV receiver 300.

The display unit 200 decompresses the compressed video signal received from the AV source unit 100 and displays the decompressed video signal on the screen.

The AV receiver 300 decompresses the compressed audio signal received from the AV source unit 100 and transmits the decompressed audio signal to a plurality of speakers. The AV receiver 330 includes the controller 310, the first output portion 320, and the second output portion 330.

More specifically, the controller 310 determines whether a current mode is normal mode or NNC mode. If the current mode is the normal mode, the controller 310 transmits audio signals of a plurality of channels (i.e., 5.1-channel audio signals) received from the AV source unit 100 to the first output portion 320.

If the current mode is the NNC mode, the controller 310 downmixes audio signals of a plurality of channels (i.e., 5.1-channel audio signals) received from the AV source unit 100 and outputs the downmixed signal to the first output portion 320. The first output portion 320 transmits the downmixed signal to the main part 411 of the center speaker 410 being the first speaker. The controller 310 receives signals of sound sensed by sound sensors 421, 431, 441 and 451, generates a cancellation signal by inverting the phases of the sensed sound signals, and outputs the cancellation signal to the second output portion 330. The second output portion 330 outputs the cancellation signal to the sub-part 412 of the center speaker 410 being the first speaker. The woofer speaker 460 is kept in a mute state.

The speaker unit 400 includes the multi-channel speakers that output 5.1-channel audio signals. The multi-channel speakers are the center speaker 410 at the front center of the display unit 200, the front speakers 420 and 430 at the left and right sides of the display unit 200, the left and right rear speakers 440 and 450 behind the user, and the woofer speaker 460. As illustrated in FIG. 6, the center speaker 410 includes the main part 411 and the sub-part 412. The left and right front speakers 420 and 430 and the left and right rear speakers 440 and 450 have the sound sensors 421, 431, 441 and 451, respectively.

In the normal mode, the center speaker 410 as the first speaker outputs clean dialogues in a film between the front speakers 420 and 430. As illustrated in FIG. 6, the center speaker 410 has the main part 411 and the sub-part 412 and outputs human voice like dialogues through the main part 411 and the sub-part 412. The left and right front speakers 420 and 430, as second speakers, output musical scores or some dialogues, and a variety of sound effects. Thus left and right front speakers 420 and 430 may create the feeling of a natural and expansive stage set. The other second speakers, i.e., the left and right rear speakers 440 and 450, may give a touching feeling by outputting additional effect sound, surrounding sound, and background sound, besides the sounds of the front speakers 420 and 430. The woofer speaker 460 outputs mid-bass sound, and thereby may give a feeling of reality and liveliness in conjunction with the front speakers 420 and 430.

In the NNC mode, the first speaker, namely the center speaker 410 outputs a downmix of 5.1-channel audio signals through the main part 411. Thus the sound sensors 421, 431, 441 and 451 are operated in the left and right front speakers 420 and 430 and the left and light rear speakers 440 and 450, sense sound output from the main part 411 of the center speaker 410 and indoor sound, and transmit the sensed sound signals to the controller 310. Also, the center speaker 410 outputs a cancellation signal through the sub-part 412. The second speakers, i.e., the left and right front speakers 420 and 430 and the left and right rear speakers 440 and 450 are in must state and the woofer speaker 460 is also in the mute state. The sound sensors 421, 431, 441 and 451 are sensors that sense sound like a microphone.

The audio system may further include a mode setter to set the current mode to the NNC mode according to user selection. Or it may be further contemplated that a current time is counted, the count is compared with a predetermined time, and the current mode is set to the NNC mode if the current time is the predetermined time, through the AV receiver 300.

In the NNC mode, sound propagation outside the installation area of the home theater should be prevented. The sound sensors 421, 431, 441 and 451 may differently sense sound output from the main part 411 of the center speaker 410 according to the distances between the center speaker 410 and the front and rear speakers 420 to 450. Therefore, a cancellation signal should be generated, taking into account the distances.

That is, the distances between the center speaker 410 and the rear speakers 440 and 450 and the distances between the center speaker 410 and the front speakers 420 and 430 are calculated based on the difference between the output time of a downmixed signal from the center speaker 410 and the time at which the downmixed signal is sensed, or using position sensors. Then the cancellation signal is generated, taking into account the distances.

In accordance with another exemplary embodiment of the present invention, the audio system includes the AV receiver 300 and the speaker unit 400. The speaker unit 400 has a plurality of speakers, each speaker including a sound sensor. The AV receiver 300 includes the controller 310, the first output portion 320, and the second output portion 330.

To be more specific, in the NNC mode, the controller 310 downmixes audio signals of a plurality of channels (i.e., 5.1-channel audio signals) received from the AV source unit 100. The first output portion 320 transmits the downmixed signal received from the controller 310 to the first speaker, that is, the center speaker 410. The controller 310 also receives signals of sound sensed by the sound sensors 421, 431, 441 and 451, generates cancellation signals by inverting the phases of the sensed sound signals, and outputs the cancellation signals to the second output portion 330. The second output portion 330 outputs the cancellation signals to the respective second speakers, that is, the left and right front speakers 420 and 430 and the left and right rear speakers 440 and 450.

In accordance with a further exemplary embodiment of the present invention, the audio system includes the AV receiver 300 and the speaker unit 400. The speaker unit 400 includes a plurality of speakers, each speaker having a sound sensor and a signal processor (not shown).

To be more specific, in the NNC mode, the AV receiver 300 downmixes audio signals of a plurality of channels (i.e., 5.1-channel audio signals) received from the AV source unit 100 and transmits the downmixed signal to the first speaker, namely the center speaker 410.

The left and right front speakers 420 and 430 and the left and right rear speakers 440 and 450 receive signals of sounds sensed by the sound sensors 421, 431, 441 and 451, generate cancellation signals by inverting the phases of the sensed sound signals at the signal processors (not shown), and output the cancellation signals.

Since phase-inverted signals of sounds sensed by the sound sensors in the installation area of the home theater system are output, the cancellation efficiency of sound reaching directly the user may be increased.

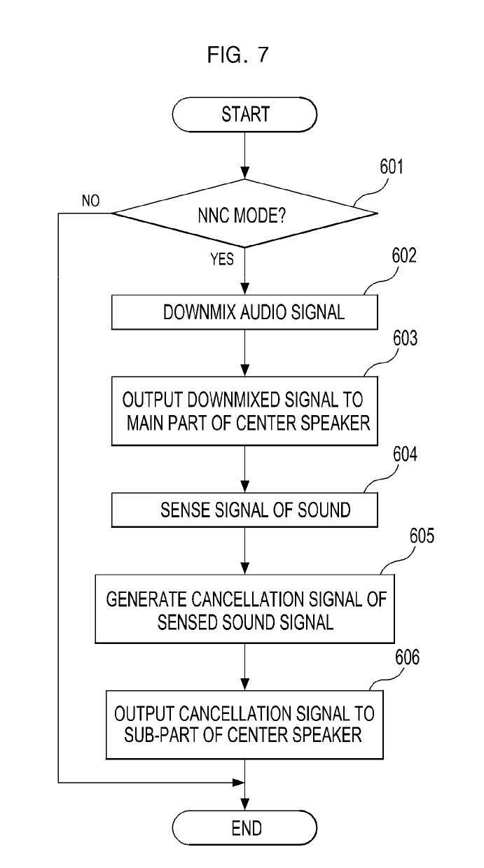

FIG. 7 is a flowchart illustrating a method to control the output of an audio system (for example, the audio system of FIG. 4) according to another exemplary embodiment of the present invention. The output control method will be described with reference to FIGS. 4 and 6.

Upon receipt of an audio signal from the AV source unit 100 such as a PVR, a DVD player or an STB, the controller 310 determines whether a current mode is the normal mode or the NNC mode and transmits signals to the first and second output portions 320 and 330 according to the result of the determination. Meanwhile, the display unit 200 decompresses a compressed video signal received from the AV source unit 100 and displays the decompressed video signal on the screen.

To be more specific, if the current mode is the normal mode, the AV receiver 300 decompresses a compressed audio signal received from the AV source unit 300 and outputs the decompressed audio signal to the first output portion 320. The first output portion 320 outputs the audio signal through each speaker. The main part 411 and the sub-part 412 of the center speaker 410 as the first speaker output clean dialogues, the woofer speaker 460 outputs mid-bass sound, the left and right front speakers 420 and 430 output a variety of sound effects, and the left and right rear speakers 440 and 450 output additional effect sounds, surrounding sound, and background sound with respect to the sounds output from the front speakers 420 and 430.

On the other hand, if the current mode is the NNC mode in operation 601, the AV receiver 300 decompresses the compressed audio signal received from the AV source unit 300 and downmixes the decompressed signal and outputs the downmixed signal to the first output portion 320 in operation 602. The first output portion 320 transmits the downmixed signal to the main part 411 of the center speaker 410 and thus the main part 411 outputs the downmixed signal in operation 603.

The sound sensors 421, 431, 441 and 451 in the left and right front speakers 420 and 430 and the left and right rear speakers 440 and 450 are operated. The sound sensors 421, 431, 441 and 451 sense sound output from the main part 411 of the center speaker 410 in operation 604 and generates a cancellation signal by inverting the phase of the sensed sound signal in operation 605. The second output portion 330 transmits the cancellation signal to the sub-part 412 of the center speaker 410 and the sub-part 412 outputs the cancellation signal in operation 606. Here, the second speakers, that is, the left and right front speakers 420 and 430 and the left and right rear speakers 440 and 450 are in a mute state. The woofer speaker 460 is also in the mute state.

In this manner, during playing a TV or any other medium, a phase-inverted signal (i.e., a cancellation signal) with the same frequency as and an opposite phase to an audio signal, is generated and output together with the audio signal, thereby canceling the audio signal. The resulting prevention of sound propagation outside an area in which the home theater is installed and the resulting increased linearity of the audio signal may increase reproduction satisfaction and improve product performance. That is, since noise made during playing a medium does not go out and external noise is not introduced inside, the installation area of the home theater may be turned into a user's private space.

Further, since the phase-inverted signal (i.e., the cancellation signal) is output to the sub-part of the center speaker, the linearity of the center speaker is increased and sound propagation outside the installation area of the home theater is prevented.

As is apparent from the above description, during playing a TV or any other medium, a phase-inverted signal (i.e., a cancellation signal) with the same frequency as and an opposite phase to an audio signal is generated and output together with the audio signal. The resulting reduction of sound propagation outside an area in which a home theater is installed blocks noise from going out. Therefore, the installation area of the home theater may be turned into a user's private space.

Also, an audio signal is output to a main part of a center speaker and a phase-inverted signal of the audio signal is output to a sub-part of the center speaker, thereby increasing the linearity of the audio signal. Accordingly, reproduction satisfaction and product performance are increased and sound propagation outside the installation area of the home theater is reduced.

Although a few exemplary embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An audio system comprising:
a source unit having an audio signal;
a receiver to receive the audio signal and generate a cancellation signal to cancel the audio signal;
a first speaker to output the audio signal; and
a second speaker to output the cancellation signal.

2. The audio system according to claim 1, wherein the second speaker includes a plurality of speakers.

3. The audio system according to claim 1, wherein the audio signal is a multi-channel audio signal and the receiver downmixes the multi-channel audio signal and transmits the downmixed signal to the first speaker.

4. The audio system according to claim 3, wherein the cancellation signal is a phase-inverted signal of the downmixed signal.

5. The audio system according to claim 1, further comprising a mode setter to set a noise canceling mode, wherein the receiver controls the generating and output of the cancellation signal if the noise canceling mode is set.

6. The audio system according to claim 5, wherein the receiver counts a current time, compares the count with a predetermined time, and sets the noise canceling mode in which the cancellation signal is generated and output, according to the comparing of the count with the predetermined time.

7. An audio system comprising:
a receiver having an audio signal;
a first speaker to output the audio signal; and
a second speaker, which has an inverting filter to invert a phase of the audio signal, to output the phase-inverted signal as a cancellation signal.

8. An audio system comprising:
a receiver having an audio signal;
a first speaker to output the audio signal; and
a second speaker, which has a sound sensor to sense sound output from the first speaker and a signal processor to generate a cancellation signal to cancel the audio signal, to output the cancellation signal.

9. An audio system comprising:
a speaker unit to output an audio signal;
a sound sensor to sense the audio signal output from the speaker unit; and
a receiver to generate a cancellation signal to cancel the audio signal, and to output the cancellation signal to the speaker unit.

10. The audio system according to claim 9, wherein the speaker unit includes a plurality of speakers, and wherein at least one of the plurality of speakers outputs the audio signal, and other speakers of the plurality of speakers output the cancellation signal.

11. The audio system according to claim 9, wherein the audio signal is a multi-channel audio signal and the speaker includes a main part to output a downmixed signal of the multi-channel audio signal and a sub-part to output the cancellation signal.

12. The audio system according to claim 9, wherein the cancellation signal is a phase-inverted signal of the sensed audio signal sensed by the sound sensor.

13. The audio system according to claim 9, further comprising a mode setter to set a noise canceling mode, wherein the receiver controls the generating and output of the cancellation signal if the noise canceling mode is set.

14. The audio system according to claim 9, wherein the receiver counts a current time, compares the count with a predetermined time, and sets the noise canceling mode, in which the cancellation signal is generated and output, according to the comparing of the count with the predetermined time.

15. A method to control output of an audio system, comprising:
determining whether a current mode is a noise canceling mode;
generating a cancellation signal to cancel an audio signal, wherein the generating of the cancellation signal is performed upon receipt of the audio signal from a source unit if the current mode is the canceling mode; and
outputting the audio signal and the cancellation signal simultaneously through different speakers.

16. The method according to claim 15, wherein the outputting of the audio signal comprises downmixing the audio signal and outputting the downmixed signal to a speaker of the different speakers.

17. The method according to claim 15, wherein the determining whether the current mode is the noise canceling mode comprises determining whether the noise canceling mode has been set through a mode setter.

18. The method according to claim 15, wherein the determination as to whether the current mode is the noise canceling mode comprises determining whether a current time is a predetermined time.

19. A method to control output of an audio system, the method comprising:
determining whether a current mode is a noise canceling mode;
outputting an audio signal through a first speaker if the current mode is the noise canceling mode;
sensing the audio signal output from the first speaker;
generating a cancellation signal to cancel sensed audio signal output from the first speaker; and
outputting the cancellation signal to a second speaker.

20. The method according to claim 19, wherein the first speaker and the second speaker are a main part and a sub-part, respectively, of a single speaker.
